(19) United States
(12) Patent Application Publication
(10) Pub. No.: US 2010/0128305 A1
(43) Pub. Date: May 27, 2010

(54) RECEIVER, IMAGE FORMING DEVICE, DATA RECEPTION METHOD AND PROGRAM STORAGE MEDIUM

(75) Inventors: Yuichi KAWATA, Kanagawa (JP); Hiroaki Yamamoto, Kanagawa (JP); Masakazu Kawashita, Kanagawa (JP); Yoshifumi Bando, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/425,065

(22) Filed: Apr. 16, 2009

(30) Foreign Application Priority Data
Nov. 26, 2008 (JP) 2008-300670

(51) Int. Cl. G06F 3/12

(52) U.S. Cl. 358/1.15

(57) ABSTRACT

A receiver includes a first storage unit, plural second storage units, a selector, a storage controller, and a selection controller. The first storage unit stores at least one packet data. The plural second storage units respectively store at least one condition associated with packet data to be stored in the first storage unit. The selector selects at least one storage unit from the second storage units in accordance with a selection signal. The storage controller stores the packet data in the first storage unit if a received packet data corresponds to any condition stored in a selected storage unit, and discards the packet data if it does not correspond to any condition. The selection controller generates a selection signal for selecting at least one second storage unit in accordance with conditions to which the packet data stored by the storage controller corresponds, and transmits the signal to the selector.

### CROSS-REFERENCE TO RELATED APPLICATION

This application is based on and claims priority under 35 USC 119 from Japanese Patent Application No. 2008-300670 filed on Nov. 26, 2008.

### BACKGROUND

1. Technical Field

The present invention relates to a receiver, an image forming device, data reception method, and program storage medium.

2. Related Art

There is known a printer that discards packets corresponding to discarding conditions including information of a filtering pattern and a specific protocol that are set in advance in a memory, and carries out power saving control in a case in which a packet is not received during a predetermined time period.

There is also known an information processing device that stores protocol information to be received and protocol information not to be received in a condition memory. If the type of the communication protocol of a predetermined layer of packet data that comes-in from a network is a type expressed by the protocol information not to be received, that packet data is extracted as an object of reception. Further, in the packet data, if the type of communication protocol of a higher level than the predetermined layer is a type expressed by protocol information not to be received, the packet data is regarded as not be an object of reception. If, as a result, packet data that is an object of reception is extracted, the device is controlled to return to a usual mode.

### SUMMARY

An aspect of the present invention is a receiver having: a first storage unit for storing at least one packet data; plural second storage units respectively storing at least one condition associated with packet data to be stored in the first storage unit; a selector selecting at least one second storage unit from the plural second storage units in accordance with a selection signal; a storage controller that, if a received packet data corresponds to any condition stored in a selected second storage unit, stores the packet data in the first storage unit, and, if the received packet data does not correspond to any condition, discards the packet data; and a selection controller generating a selection signal for selecting, from the plurality of second storage units, at least one second storage unit in accordance with conditions to which the packet data stored by the storage controller corresponds, and transmitting the selection signal to the selector.

### BRIEF DESCRIPTION OF THE DRAWINGS

An exemplary embodiment of the present invention will be described in detail based on the following figures, wherein:

FIG. 1 is a functional block diagram of an image forming device relating to the exemplary embodiment;

FIG. 2 is a block diagram showing the structure of a device controller;

FIG. 3 is a block diagram showing the structure of a reception controller;

FIG. 4A is a drawing showing examples of conditions that are respectively stored in five condition memories that are provided at a selection condition supplying section of a TCP system;

FIG. 4B is a drawing showing examples of conditions that are respectively stored in three condition memories that are provided at a selection condition supplying section of an ICMP system;

FIG. 5A is a drawing showing examples of selection rules of the condition memories of the TCP system;

FIG. 5B is a drawing showing examples of selection rules of the condition memories of the ICMP system;

FIG. 6A is a timing chart of packet data and an effective (enable) signal transmitted from a communication interface;

FIG. 6B is a timing chart of respective signals in a case in which packet data to be stored is received in a state in which a condition memory in which a filter F1_{TCP} is stored is selected;

FIG. 6C is a timing chart of respective signals in a case in which packet data to be discarded is received in a state in which the condition memory 54 in which the filter F1_{TCP} is stored is selected;

FIG. 7 is a drawing showing an example of packet data that is exchanged between the image forming device and an external device;

FIG. 8A is a drawing showing the structure of TCP/IP protocol packet data;

FIG. 8B is a drawing showing the structure of ICMP protocol packet data;

FIG. 9 is a drawing showing the detailed structure of an Ethernet header;

FIG. 10 is a drawing showing the detailed structures of an IP header and an ICMP header; and

FIG. 11 is a drawing showing the detailed structure of a TCP header.

### DETAILED DESCRIPTION

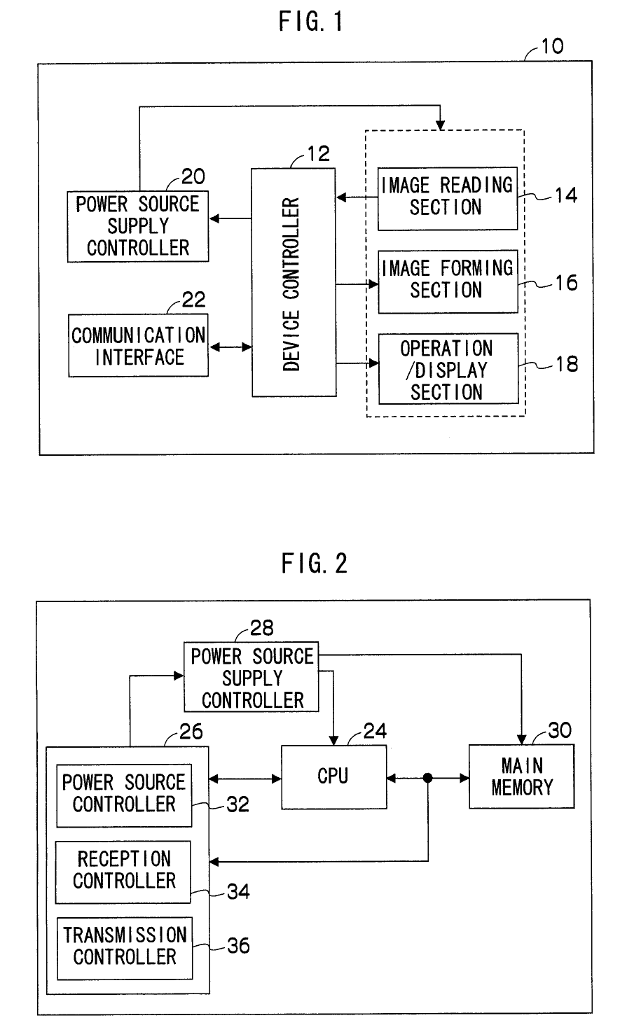

A functional block diagram of an image forming device 10 relating to an exemplary embodiment is shown in FIG. 1.

As shown in FIG. 1, the image forming device 10 has a device controller 12, an image reading section 14, an image forming section 16, an operation/display section 18, a power source supply controller 20 and a communication interface 22.

The image reading section 14 optically reads the image of a document that is placed on an unillustrated document placement table or a document that is conveyed by a document conveyer, and transfers the image information (data) obtained by reading to the device controller 12.

The image forming section 16 forms an image, that is expressed by image data read at the image reading section 14 or image data received via the communication interface 22, onto a recording medium such as a sheet or the like.

The operation/display section 18 is structured by, for example, a touch panel display or the like, and functions as a display section that displays images or information such as various messages or the like in accordance with control signals inputted from a CPU 24 that will be described later, and also functions as an input section by which a user instructs and inputs by designating an arbitrary position on the image displayed on the operation/display section 18. The operation/display section 18 is not limited to a touch panel display. For example, a display section such as a liquid crystal display, and an input section such as operation buttons that are operated by an operator, may be provided separately.

The power source supply controller 20 is connected to an unillustrated power source and, in accordance with power source supply control signals received from the device controller 12, supplies electric power to or stops the supply of electric power to the image reading section 14, the image forming section 16 and the operation/display section 18.

The communication interface 22 is connected to a network such as an Ethernet® or the like, and transmits to the device controller 12 data that is received from the network, and receives from the device controller 12 data to be transmitted and transmits it to the network.

In the exemplary embodiment, an Ethernet® is used as the network. Packet data based on various types of protocols such as Transmission Control Protocol/Internet Protocol (TCP/IP), User Datagram Protocol/Internet Protocol (UDP/IP), and the like are transmitted by the network. However, unnecessary packet data that does not need to be received at the image forming device 10 is also transmitted. Therefore, the device controller 12 carries out storage control (filtering) so as to store the necessary packet data among the packet data that come-in via the network, and discard the unnecessary packet data.

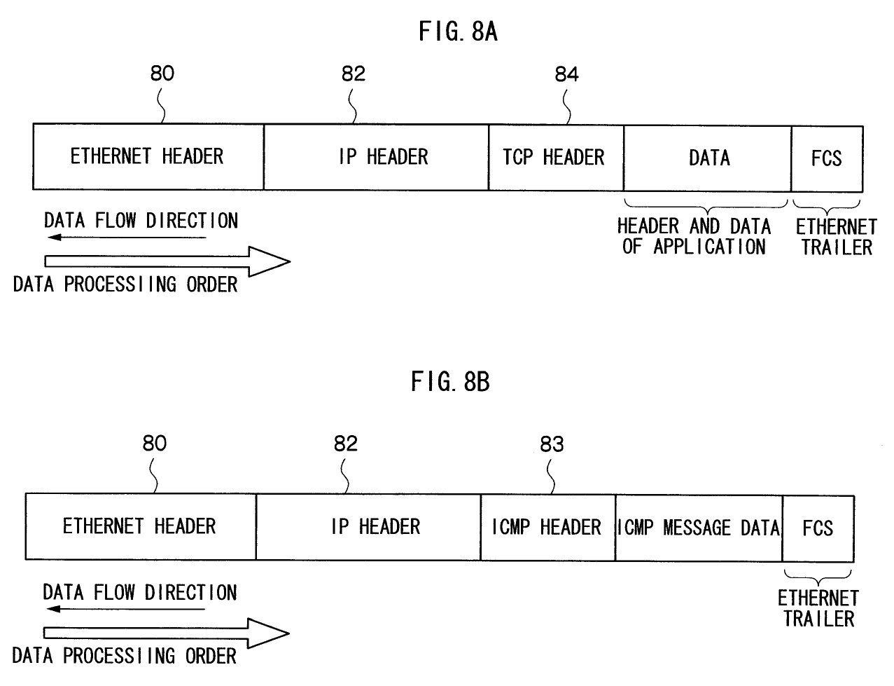

FIG. 8A and FIG. 8B show the structures of TCP/IP protocol and Internet Control Message Protocol (ICMP) protocol packet data that are transmitted by the network relating to the exemplary embodiment. As shown in FIG. 8A, the TCP/IP protocol data includes an Ethernet header 80, an IP header 82, a TCP header 84, a header and data of an application, and an Ethernet trailer. Further, as shown in FIG. 8B, the ICMP protocol data includes the Ethernet header 80, the IP header 82, an ICMP header 83, ICMP message data, and an Ethernet trailer.

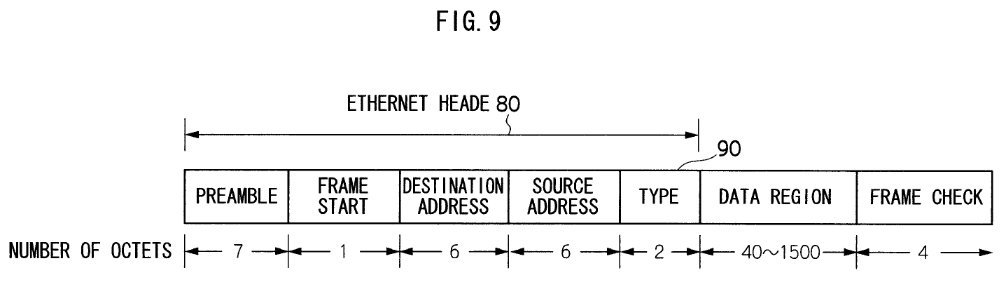

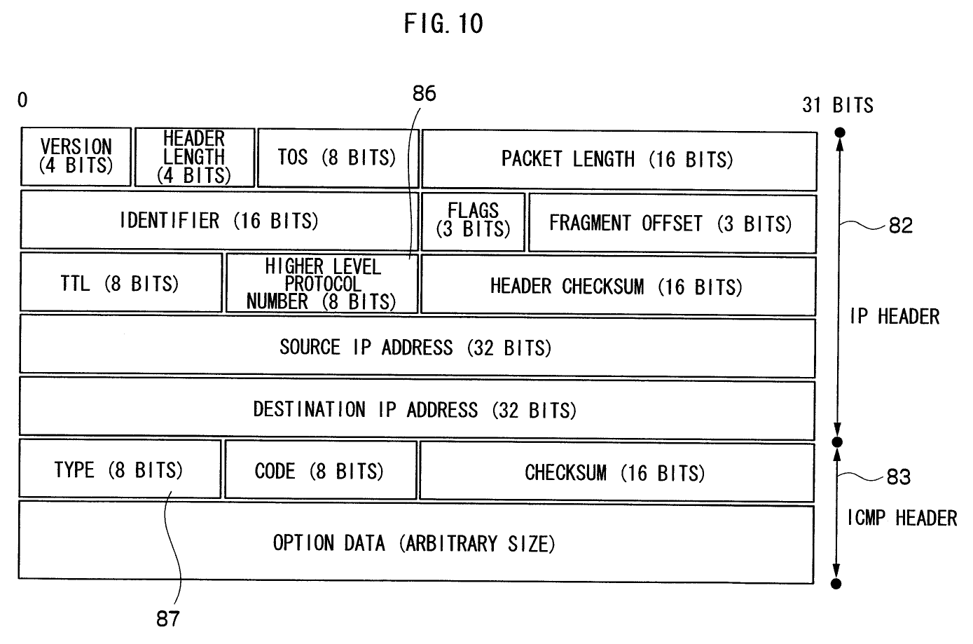

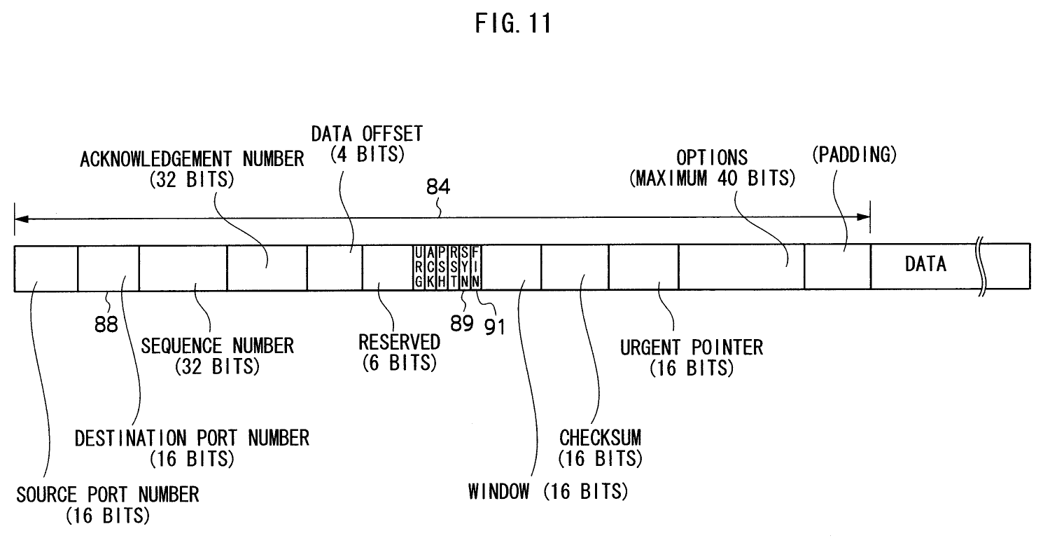

FIG. 9 is a drawing showing the detailed structure of the Ethernet header 80. FIG. 10 is a drawing showing the detailed structures of the IP header 82 and the ICMP header 83. FIG. 11 is a drawing showing the detailed structure of the TCP header 84. There are also cases in which the packet data includes a UDP header instead of the TCP header 84, but description thereof is omitted here.

The device controller 12 is connected to the image reading section 14, the image forming section 16, the operation/display section 18, the power source supply controller 20, and the communication interface 22. The device controller 12 carries out control of the image reading operations of the image reading section 14, control of the transmission and reception of data to and from the network via the communication interface 22, control of the image forming operations by the image forming section 16 onto recording media, control of display of various types of information on the operation/display section 18, and the like.

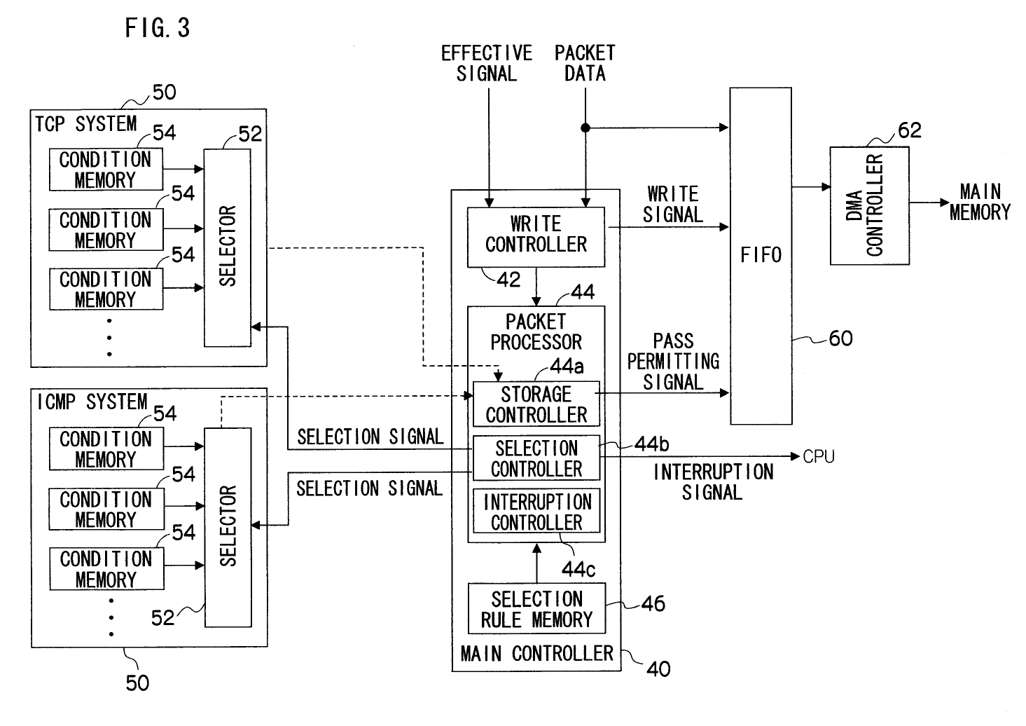

FIG. 2 is a block diagram showing the structure of the device controller 12.

As shown in FIG. 2, the device controller 12 is structured to include the Central Processing Unit (CPU) 24, a power source and communications controller 26, a power source supply controller 28, and a main memory 30. The CPU 24, the power source and communications controller 26, and the main memory 30 are connected to one another via an unillustrated bus.

The CPU 24 executes programs that are stored in an unillustrated memory (e.g., a hard disk drive, a Read Only Memory (ROM), or the like), and controls the operations of the various structural sections that structure the image forming device 10, such as the image reading section 14, the image forming section 16, the operation/display section 18.

The power source supply controller 28 is connected to an unillustrated power source, and supplies electric power to the CPU 24 and the main memory 30.

The main memory 30 is structured by, for example, a Dynamic Random Access Memory (DRAM). The main memory 30 has the function of independently carrying out refreshing automatically at the main memory 30 (a self-refresh function). In the midst of a power saving mode (self-refresh mode), the main memory 30 puts to sleep portions other than the paths that execute the self-refresh function, so as to curtail the amount of electric power that is consumed. Because the main memory 30 itself automatically caries out refreshing by the self-refresh function, the stored data does not disappear.

The transitioning of the main memory 30 from the usual operation mode (non power saving mode) to the self-refresh mode, and the return from the self-refresh mode to the usual operation mode, are carried out in accordance with commands of the CPU 24.

The power source and communications controller 26 has a power source controller 32, a reception controller 34, and a transmission controller 36.

The power source controller 32 sends power source supply control signals to the power source supply controller 28, and carries out or stops the supply of electric power to the CPU 24. The power source controller 32 maintains the electric power level during the self-refresh mode of the main memory 30 via the power source supply controller 28. The power source controller 32 sends power source supply control signals to the power source supply controller 20 in accordance with control signals from the CPU 24, and carries out or stops the supply of electric power to the image reading section 14, the image forming section 16 and the operation/display section 18.

The image forming device 10 relating to the exemplary embodiment has a non power saving mode in which driving electric power is supplied to the image reading section 14, the image forming section 16, the operation/display section 18 and the CPU 24 such that these sections are set in states in which image reading and image formation can be executed, and a power saving mode in which the amount of consumed electric power is made to be less than in the non power saving mode by stopping the supply of driving electric power to the image reading section 14, the image forming section 16, the operation/display section 18 and the CPU 24.

However, the power source and communications controller 26, the power source supply controller 20 and the power source supply controller 28 are kept running even during the power saving mode.

The reception controller 34 and the transmission controller 36 are connected to the communication interface 22. The reception controller 34 filters the packet data transmitted from the communication interface 22. In accordance with commands from the CPU 24, the transmission controller 36 generates packet data and transmits the packet data to the network via the communication interface 22.

The power supply and communications controller 26 is structured by hardware such as an Application Specific Integrated Circuit (ASIC) or the like.

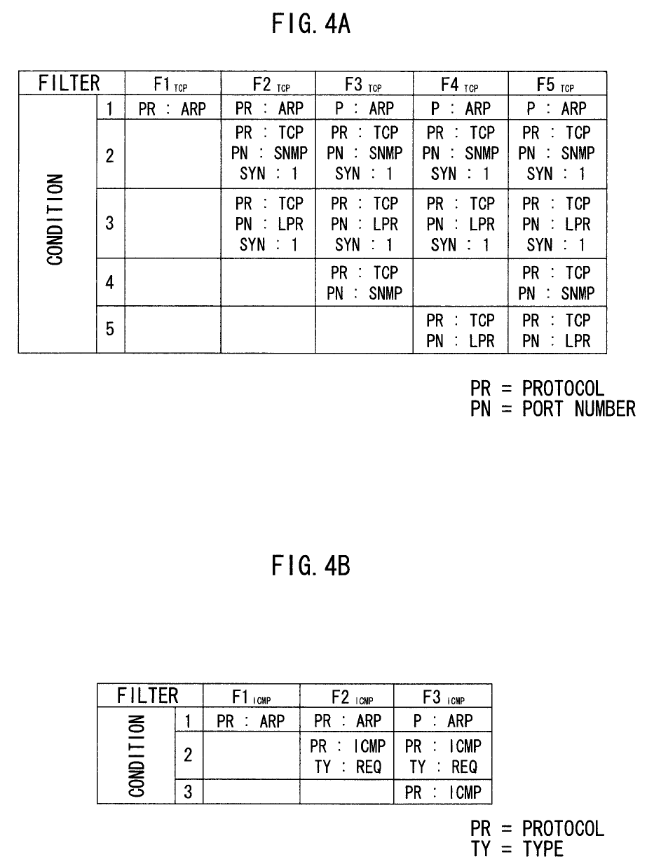

FIG. 3 is a block diagram showing the structure of the reception controller 34.

The reception controller 34 includes a main controller 40, plural selection condition supplying sections 50, a First-in First-out Buffer (FIFO) 60, and a Direct Memory Access (DMA) controller 62.

Each of the selection condition supplying sections 50 has a selector 52 and plural condition memories 54.

The selector 52 selects one of the condition memories 54 from the plural condition memories 54 in accordance with a selection signal from the main controller 40, and supplies the conditions stored in the selected condition memory 54 to the main controller 40. At least one condition of packet data to be stored is stored in advance in each of the plural condition memories 54. The condition memory 54 may be structured by a semiconductor memory element such as an Erasable Programmable Read Only Memory (EPROM), an Electrically Erasable and Programmable Read Only Memory (EEPROM), a Flash EEPROM, a Flash memory or the like, or the like.

In the exemplary embodiment, as shown in FIG. 3, the selection condition supplying section 50 is provided for each protocol of the predetermined network layer (the network layer to be used), such as the selection condition supplying section 50 of the TCP system, the selection condition supplying section 50 of the ICMP system, . . . . The condition memory 54 that is to be used is selected per protocol.

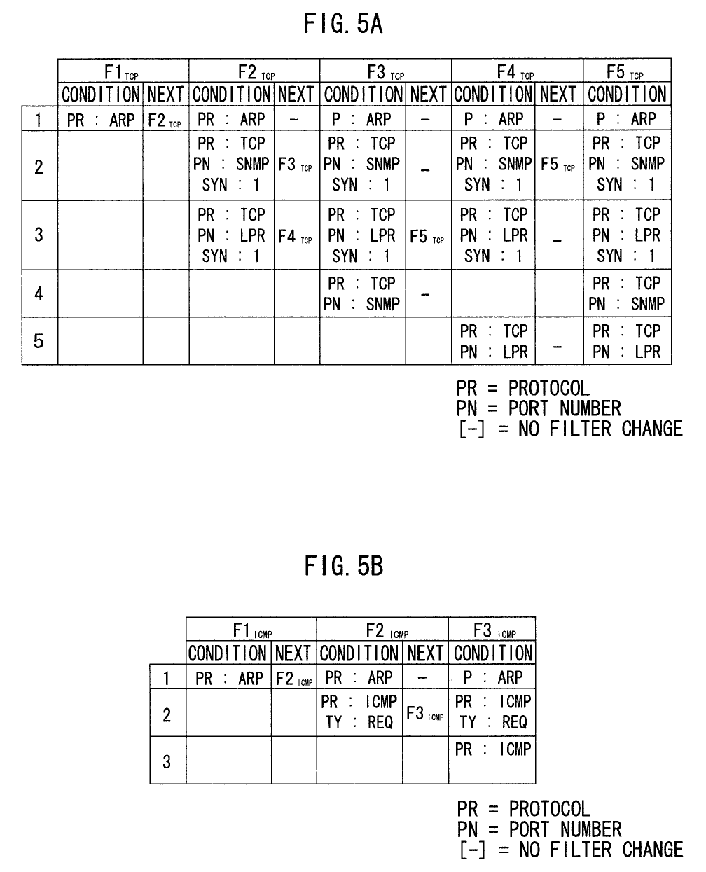

FIG. 4A is a drawing showing examples of conditions that are respectively stored in the five condition memories 54 provided at the selection condition supplying section 50 of the TCP system. Here, the set of the conditions stored in each condition memory 54 is called a filter. Further, description is given by differentiating as follows: the set of the conditions stored in the first condition memory 54 of the TCP system are called filter F1_{TCP}, the set of the conditions stored in the second condition memory 54 are called filter F2_{TCP}, the set of the conditions stored in the third condition memory 54 are called filter F3_{TCP}, the set of the conditions stored in the fourth condition memory 54 are called filter F4_{TCP}, and the set of the conditions stored in the fifth condition memory 54 are called filter F5_{TCP}.

Conditions such as the IP addresses of the destination and the source, the port numbers of the destination and the source, the protocol, flags or types showing the attributes of the packet data, and the like are defined in the respective filters F1_{TCP} through F5_{TCP}.

The filter F1_{TCP} is the filter that is stored in the first condition memory 54 selected at the time of the power saving mode. The filters F2_{TCP} through F5_{TCP} are filters that are stored in the second through fifth condition memories 54 that are selected at the time of the non power saving mode.

At least one of the following five conditions is included in the filters F1_{TCP} through F5_{TCP} of the TCP system.

Condition 1: protocol “ARP”

Condition 2: protocol “TCP” and port number “SNMP” (=No. 25) and flag SYN “1”

Condition 3: protocol “TCP” and port number “LPR” (=No. 515) and flag SYN “1”

Condition 4: protocol “TCP” and port number “SNMP”

Condition 5: protocol “TCP” and port number “LPR”

Address Resolution Protocol (ARP) is a protocol that is used in order to determine the physical address (MAC address) of the Ethernet® from the IP address. Simple Network Management Protocol (SNMP) is a protocol for monitoring and managing the network system. Line PRinter daemon protocol (LPR) is a protocol for carrying out printing via the TCP/IP network. Synchronize Flag (SYN flag) is a flag that becomes 1 at the initially transmitted packet in the TCP connection, and is used in the connection establishing process.

Concretely, as shown in FIG. 4A, the filter F1_{TCP} includes condition 1, the filter F2_{TCP} includes three conditions that are conditions 1, 2, 3, the filter F3_{TCP} includes four conditions that are conditions 1, 2, 3, 4, the filter F4_{TCP} includes four conditions that are conditions 1, 2, 3, 5, and the filter F5_{TCP} includes five conditions that are conditions 1 through 5.

Although not illustrated, a condition that the destination IP address is the self-address or is a broadcast address also is defined in the respective conditions structuring the filters F1_{TCP} through F5_{TCP}. Accordingly, in the storage control, packet data whose destination IP address is other than the self-address or a broadcast address is not stored, no matter which of the filters is applied.

FIG. 4B is a drawing showing examples of conditions that are respectively stored in the three condition memories 54 provided at the selection condition supplying section 50 of the ICMP system. Description is given by differentiating as follows: the set of the conditions stored in the first condition memory 54 of the ICMP system are called filter F1_{ICMP}, the set of the conditions stored in the second condition memory 54 are called filter F2_{ICMP}, and the set of the conditions stored in the third condition memory 54 are called filter F3_{ICMP}.

In the same way as the above-described filters of the TCP system, conditions such as the IP addresses of the destination and the source, the protocol, flags or types showing the attributes of the packet data, and the like are defined in the respective filters F1_{ICMP} through F3_{ICMP}.

The filter F1_{ICMP} is the filter that is stored in the first condition memory 54 selected at the time of the power saving mode. Further, the filters F2_{ICMP} and F3_{ICMP} are filters that are stored in the second and third condition memories 54 selected at the time of the non power saving mode.

At least one of the following three conditions is included in the filters F1_{ICMP} through F3_{ICMP} of the ICMP system.

Condition 1: protocol “ARP”

Condition 2: protocol “ICMP” and type “request”
Condition 3: all packets of protocol “ICMP”

Concretely, as shown in FIG. 4B, the filter F1_{ICMP} includes condition 1, the filter F2_{ICMP} includes two conditions that are conditions 1, 2, and the filter F3_{ICMP} includes three conditions that are conditions 1 through 3.

Although not illustrated, a condition that the destination IP address is the self-address or is a broadcast address also is defined in each of the conditions structuring the filters F1_{ICMP} through F3_{ICMP}. Accordingly, packet data whose destination IP address is other than the self-address or a broadcast address is not stored, no matter which of the filters is applied.

The exemplary embodiment describes a case in which the selection condition supplying section 50 is provided for each protocol of the predetermined network layer, as described above. However, it is possible to provide only one selection condition supplying section 50, and to provide, at the selection condition supplying section 50, plural condition memories 54 that store filters including conditions that extend over plural protocols, and to select the condition memory 54 that is to be used.

The main controller 40 has a write controller 42, a packet processor 44 and a selection rule memory 46.

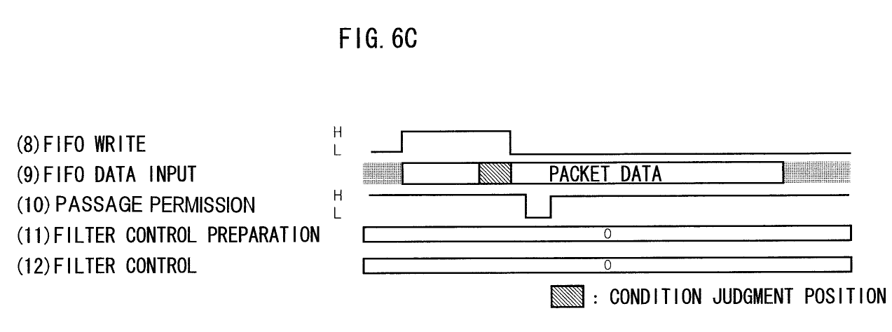

Effective (enable) signals and packet data are transmitted to the main controller 40 from the communication interface 22. The main controller 40 handles the packet data, that is transmitted when the effective signal is H (high) level, as effective packet data (refer to FIG. 6A as well).

When reception of effective packet data is started, the write controller 42 transmits an H level write signal to the FIFO 60 so that that packet data is written to the FIFO 60. When reception of effective packet data ends (i.e., when the effective signal becomes L (low) level), or when a storage controller 44a judges that the packet data is packet data that is to be discarded, the write controller 42 changes the write signal to L level (refer to FIG. 6B and FIG. 6C as well).

When reception of effective packet data ends (i.e., when the effective signal becomes L level), or when the storage controller 44a judges that the packet data is packet data that is to be stored, the write controller 42 changes the write signal to L level, and thereafter, transmits a write end signal to the FIFO 60.

The packet processor 44 has various functions (the storage controller 44a, a selection controller 44b, and an interruption controller 44c) that relate to filtering.

The storage controller 44a of the packet processor 44 compares effective packet data with the conditions that are stored in the condition memory 54 selected by the selection condition supplying section 50, and judges whether the packet data is an object of storing (corresponds to the conditions) or is an object of discarding (does not correspond to the conditions). If the packet data does not correspond to any of the conditions, the packet processor 44 changes a pass permitting signal to L level, and in other cases, maintains the H level.

For example, in a state in which the filter F2_{TCP} of FIG. 4A is selected as the condition memory 54 of the TCP system, if the received packet data corresponds to any of the three conditions of the filter F2_{TCP}, the received packet data is judged to be an object of storing (object packet data), and the pass permitting signal is maintained at H level as is. In a state in which the filter F2_{TCP} of FIG. 4A is selected, if the received packet data does not correspond to any of the three conditions of the filter F2_{TCP}, the received packet data is judged to be an object of discarding (discard packet data), and the pass permitting signal is changed to L level.

The selection controller 44b of the packet processor 44 generates a selection signal and transmits the selection signal to the selector 52 so that the condition memory 54, that corresponds to the conditions that the object packet data corresponds to, is selected.

When the image forming device 10 is in the power saving mode, and when packet data corresponding to conditions stored in the condition memory 54 selected at the selection condition supplying section 50 is detected, the interruption controller 44c of the packet processor 44 generates an interruption signal for activating the CPU 24 that is stopped, and transmits the interruption signal to the CPU 24. The CPU 24 thereby returns from the power saving mode to the non power saving mode.

Note that, before the CPU 24 returns from the power saving mode (the stopped state) to the non power saving mode (the activated state), the power source controller 32 of the power source and communications controller 26 generates a control signal for starting the supply of electric power to the CPU 24, and transmits the control signal to the power source supply controller 28. The power source supply controller 28 thereby starts the supply of electric power to the CPU 24 that is stopped.

Information (data) that expresses the selection rules of the condition memories 54 is stored in the selection rule memory 46. As described above, the packet processor 44 generates a selection signal and transmits the selection signal to the selector 52 so that the condition memory 54, that corresponds to the conditions that the object packet data corresponds to, is selected. At the time of generating the selection signal, the packet processor 44 generates the selection signal by referring to the selection rules that are stored in the selection rule memory 46.

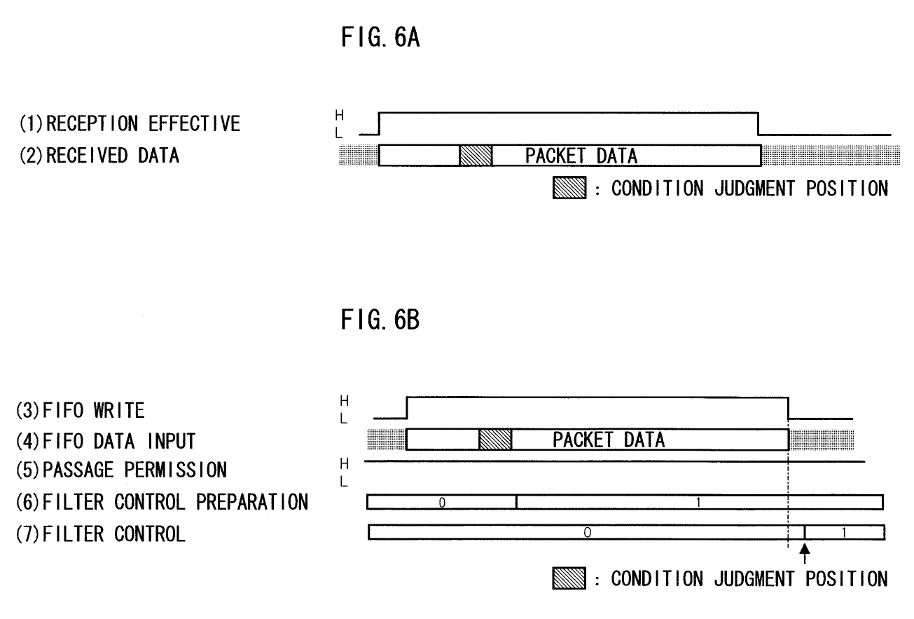

Examples of selection rules of the condition memories 54 of the TCP system are shown in FIG. 5A, and examples of selection rules of the condition memories 54 of the ICMP system are shown in FIG. 5B.

Here, the selection rules of the condition memories 54 of the TCP system will be described in detail. For example, in the exemplary embodiment, at the time of the power saving mode, the condition memory 54 in which the filter F1_{TCP} is stored is selected. In a case in which the received packet data corresponds to the conditions of the filter F1_{TCP}, the condition memory 54 in which the filter F2_{TCP} is stored is selected as the filter to be applied from the packet data that is to be received next.

In a case in which the condition memory 54 in which the filter F2_{TCP} is stored is selected and the packet data received at that time corresponds to “condition 2” of the filter F2_{TCP}, the condition memory 54 in which the filter F3_{TCP} is stored is selected as the filter to be applied from the packet data that is to be received next.

In a case in which the condition memory 54 in which the filter F2_{TCP} is stored is selected and the packet data received at that time corresponds to “condition 3” of the filter F2_{TCP}, the condition memory 54 in which the filter F4_{TCP} is stored is selected as the filter to be applied from the packet data that is to be received next.

In a case in which the condition memory 54 in which the filter F2_{TCP} is stored is selected and the packet data received at that time corresponds to “condition 1” of the filter F2_{TCP}, switching of the condition memory 54 is not carried out, and the condition memory 54 in which the filter F2_{TCP} is stored is continuously selected.

The selection controller 44b of the packet processor 44 of the exemplary embodiment generates selection signals 0 through 4 for the selection condition supplying section 50 of the TCP system. The selector 52 of the selection condition supplying section 50 of the TCP system selects the first condition memory 54 in which the filter F1_{TCP} is stored when the selection signal is 0, selects the second condition memory 54 in which the filter F2_{TCP} is stored when the selection signal is 1, selects the third condition memory 54 in which the filter F3_{TCP} is stored when the selection signal is 2, selects the fourth condition memory 54 in which the filter F4_{TCP} is stored when the selection signal is 3, and selects the fifth condition memory 54 in which the filter F5_{TCP} is stored when the selection signal is 4.

The selection of the condition memory 54 of the ICMP system also is carried out in accordance with the selection rules shown in FIG. 5B. The selection controller 44b of the packet processor 44 of the exemplary embodiment generates selection signals 0 through 2 for the selection condition supplying section 50 of the ICMP system. The selector 52 of the selection condition supplying section 50 of the ICMP system selects the first condition memory 54 in which the filter F1_{ICMP} is stored when the selection signal is 0, selects the second condition memory 54 in which the filter F2_{ICMP} is stored when the selection signal is 1, and selects the third condition memory 54 in which the filter F3_{ICMP} is stored when the selection signal is 2.

Note that the selection rule memory 46 may be structured by a semiconductor memory element such as an EPROM, an EEPROM, a Flash EEPROM, a Flash memory or the like, or the like.

The FIFO 60 is a first-in first-out type buffer, and is structured by, for example, a write pointer, a read pointer, a register and a pointer control circuit. At the time of writing packet data, the packet data is successively stored in the register region of the address indicated by the write pointer. At the time of reading-out packet data, the packet data is successively read-out from the register region of the address indicated by the read pointer. The write pointer is updated by the pointer control circuit in accordance with a write signal. The read pointer is updated by the pointer control circuit in accordance with a transfer end interruption signal of the DMA controller 62.

Packet data is transmitted to the FIFO 60 from the communication interface, and a write signal and a write end signal are transmitted to the FIFO 60 from the write controller 42 of the main controller 40, and a pass permitting signal is transmitted to the FIFO 60 from the packet processor 44. When the write signal is H level, the FIFO 60 writes the packet data, that is transmitted from the communication interface 22, to its register region of the address indicated by the write pointer. Further, when the write signal becomes L level, writing of the packet data is stopped. Moreover, when the pass permitting signal becomes L level, the FIFO 60 discards the packet data that is written in the FIFO 60. Namely, the address that the write pointer indicates is returned to the position before the writing of that packet data, and the data stored in the written portion is deleted from the FIFO 60. In addition, when a write end signal is transmitted from the write controller 42, the FIFO 60 determines to store the written packet data.

The DMA controller 62 transfers the packet data, that is stored in the FIFO 60 without the pass permitting signal becoming L level and that is determined by the write end signal to be stored, to the main memory 30 without going through the CPU 24, and stores the packet data in the main memory. When the DMA transfer ends, the DMA controller 62 transmits a DMA transfer end signal to the FIFO 60.

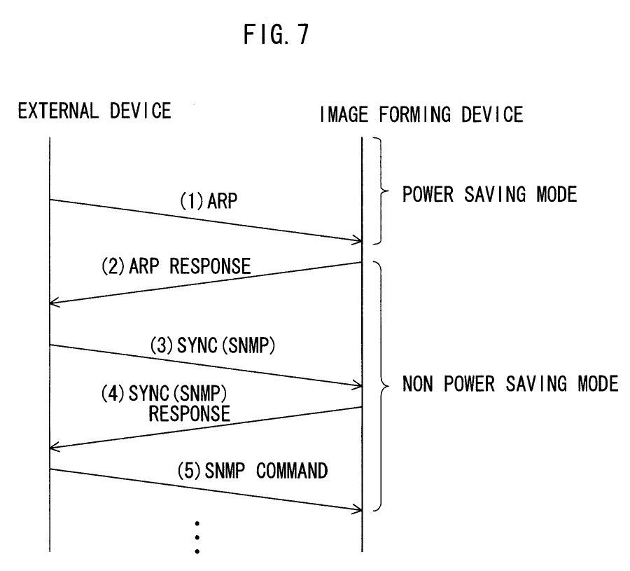

A concrete example of reception control of the reception controller 34 relating to the exemplary embodiment will be described next with reference to FIG. 6A through FIG. 6C and FIG. 7. Here, description will focus on the filters of the TCP system.

After activation of the image forming device 10, the selection controller 44b of the packet processor 44 generates the selection signal 4 and transmits it to the selector 52 of the selection condition supplying section 50 of the TCP system. Due thereto, the condition memory 54 that stores the filter F5_{TCP}, at which the number of types of object packets is the greatest, is selected.

If operation of the operation/display section 18 is not carried out within a predetermined time period, or if packet data is not received in a predetermined time period from the network via the communication interface 22, or the like, the image forming device 10 transitions to the power saving mode. When the image forming device 10 transitions to the power saving mode, the CPU 24 sets the main memory 30 to the self-refresh mode, and thereafter, writes data, that expresses transition to the power saving mode, to a power saving mode transition instruction register provided within the CPU 24. When writing to the power saving mode transition instruction register is carried out, the power source controller 32 transmits a power source supply control signal that stops the supply of electric power to the power source supply controller 20 and the power source supply controller 28. Due thereto, the power source supply controller 20 stops the supply of electric power to the image reading section 14, the image forming section 16 and the operation/display section 18, and the power source supply controller 28 stops the supply of electric power to the CPU 24.

When writing to the power saving mode transition instruction register is carried out, the selection controller 44b of the packet processor 44 of the reception controller 34 generates the selection signal 0 and transmits it to the selector 52 of the selection condition supplying section 50 of the TCP system. The condition memory 54 that stores the filter F1_{TCP}, at which the number of types of object packets is the least, is thereby selected. During the selection of the filter F1_{TCP}, the storage controller 44a of the packet processor 44 carries out storage control of the packet data in accordance with “condition 1” of the filter F1_{TCP}.

FIG. 6A is a drawing showing a timing chart of an effective signal and packet data that are transmitted from the communication interface 22. As shown in FIG. 6A, during the reception of the effective packet data ((2) in FIG. 6A), an H-level effective signal is transmitted from the communication interface 22 to the packet processor 44 ((1) in FIG. 6A).

FIG. 6B is a timing chart of respective signals in a case of receiving packet data to be stored (an ARP request) as shown in (1) of FIG. 7, in a state in which the condition memory 54 in which the filter F1_{TCP} is stored is selected.

When reception of the effective packet data is started as described above, the write controller 42 transmits an H-level write signal to the FIFO 60 ((3) of FIG. 6B). When the write signal is H-level, the packet transmitted from the communication interface 22 is successively written in the FIFO 60 ((4) in FIG. 6B).

On the other hand, the storage controller 44a of the packet processor 44 compares the packet data transmitted from the communication interface 22 and the condition (condition 1 in FIG. 4A) of the filter F1_{TCP} stored in the condition memory 54 that is currently selected, and judges whether that packet data is an object of storing (object packet data) or is an object of discarding (discard packet data).

Concretely, the packet data is transmitted to the main controller 40 in the direction of the thick arrow shown in FIG. 8A (in order from the head of the packet data). Accordingly, at the time when the storage controller 44a receives the position of the packet data at which condition 1 of the filter F1_{TCP} is to be judged (condition judgment position: the hatched portion of (4) of FIG. 6B), the storage controller 44a compares the data in the condition judgment position and condition 1. In this case, since condition 1 of the filter F1_{TCP} defines that the protocol is ARP, the condition judgment position will be the position of a type 90 (see FIG. 9) of the Ethernet header 80.

If the value of the type 90 of the packet data is “0X0806”, it matches condition 1. Therefore, the storage controller 44a judges that the packet data is object packet data, and maintains the H level of the pass permitting signal ((5) in FIG. 6B). Writing-in to the FIFO 60 is thereby continued.

Further, the condition of the filter F1_{TCP} is the condition at the time of the power saving mode. Therefore, if it is judged that the packet data is object packet data, the power source controller 32 transmits to the power source supply controller 28 a power source supply control signal for starting the supply of electric power to the CPU 24, and the interruption controller 44c generates an interruption signal for activating the CPU 24 and transmits the interruption signal to the CPU 24. Due thereto, the CPU 24 is activated, and the mode switches from the power saving mode to the non power saving mode. Note that some time is required until the CPU 24 is initialized and completely returned to non power saving mode, but the storage control processing of the packet data is carried out by the reception controller 34 and is not affected. Further, after activation of the CPU 24, the main memory 30 is switched by the CPU 24 from the self-refresh mode to the usual operation mode. Moreover, a control signal is sent from the CPU 24 to the power source controller 32 such that the supply of electric power to the image reading section 14, the image forming section 16 and the operation/display section 18 is restarted. In accordance with this control signal, the power source controller 32 sends a power source supply control signal to the power source supply controller 20, and restarts the supply of electric power to the image reading section 14, the image forming section 16 and the operation/display section 18.

The selection controller 44b of the packet processor 44 refers to the selection rules stored in the selection rule memory 46, and determines the condition memory 54 that is to be selected next in accordance with the condition (condition 1) that the object packet data corresponds to. As shown in FIG. 5A, if the packet data corresponds to condition 1 of the filter F1_{TCP}, the condition memory 54 that is to be selected next is the condition memory 54 in which the filter F2_{TCP} is stored. Accordingly, the selection controller 44b generates the selection signal 1 and prepares change of selection of condition memory 54 ((6) in FIG. 6B), so that the condition memory 54 in which the filter F2_{TCP} is stored is selected. After generation of the selection signal, transmission of the selection signal stands-by until the write signal becomes L level.

When reception of the effective packet data ends (i.e., when the effective signal becomes L level), the write controller 42 changes the write signal to L level. When the write signal is changed to L level, the writing of the packet data to the FIFO 60 is stopped. Note that, in order to carry out storage control by applying the filter F2_{TCP} that is stored in the newly-selected condition memory 54 with respect to the packet data to be received next after the packet data corresponding to the condition of filter F1_{TCP}, the selection controller 44b transmits the generated selection signal 1 to the selector 52 of the selection condition supplying section 50 of the TCP system ((7) in FIG. 6B) after the write signal becomes L level and before the next effective packet data is received.

Usually, when packet data are transmitted continuously, a transmission interval that should be at least ensured is determined in advance. The selection signal is transmitted to the selector 52 by using this transmission interval.

When the selector 52 receives the selection signal 1, instead of the first condition memory 54, the selector 52 selects the second condition memory 54 that corresponds to the received selection signal 1. Due thereto, storage control based on the filter F2_{TCP} stored in that second condition memory 54 is carried out from the packet data that is received next.

When the receiving of the effective packet data ends (the effective signal becomes L level) and the packet data is judged at the storage controller 44a to be object packet data, the write controller 42 changes the write signal to L level, and then, transmits a write end signal to the FIFO 60 (illustration of the write end signal is omitted).

FIG. 6C is a timing chart of respective signals in a case in which packet data to be discarded (discard packet data) is received, when the condition memory 54 in which the filter F1_{TCP} is stored is selected.

When receiving of effective packet data is started as described above, the write controller 42 transmits an H-level write signal to the FIFO 60 ((8) of FIG. 6C). When the write signal is H level, the packet data that is transmitted from the communication interface 22 is successively written in the FIFO 60 ((9) in FIG. 6C).

On the other hand, the storage controller 44a of the packet processor 44 compares the packet data transmitted from the communication interface 22 and the condition (condition 1 of FIG. 4A) of the filter F1_{TCP} stored in the condition memory 54 that is currently selected, and judges whether that packet data is object packet data or is discard packet data.

Concretely, the storage controller 44a compares data stored in the condition judgment position of the packet data (the condition judgment position: the hatched portion of (9) of FIG. 6C) and condition 1. Here, since condition 1 of the filter F1_{TCP} defines that the protocol is ARP, the condition judgment position is the position of the type 90 (see FIG. 9) of the Ethernet header 80.

If the value of the type 90 of the packet data is not “0X0806”, the packet data does not correspond to condition 1, and therefore is discard packet data. In this way, if the packet data does not correspond to condition 1, the write controller 42 changes the write signal to L level ((8) in FIG. 6C). When the write signal is changed to L level, writing of the packet data to the FIFO 60 is stopped.

Further, if the packet data does not correspond to condition 1, the storage controller 44a changes the pass permitting signal to L level ((10) in FIG. 6C). When the pass permitting signal is L level, the FIFO 60 discards the packet data that has been written in the FIFO 60 until now.

Moreover, if it is judged that the packet data is discard packet data, the selection controller 44b of the packet processor 44 does not change the selection of the condition memory 54. Accordingly, a new selection signal is not generated, and the condition memory 54 that stores the filter F1_{TCP} is continuously selected ((11) and (12) in FIG. 6C).

When packet data of an ARP request is received at (1) of FIG. 7, this packet data corresponds to “condition 1” of the filter F1_{TCP} as described above. Therefore, the packet data is stored in the FIFO 60, and further, is stored in the main memory 30 by DMA transfer. As shown in (2) of FIG. 7, the CPU 24 that has been activated by the interruption signal generates a response to the ARP request stored in the main memory 30, and transmits the packet data of the ARP response to the network via the transmission controller 36 and the communication interface 22.

Thereafter, as shown in (3) of FIG. 7, when a TCP_SYNC request of SNMP (the initially generated packet of the TCP/IP communication; a packet of protocol “TCP” and port number “SNP” and SYN flag “1”) is received, that packet data is compared with the respective conditions (conditions 1 through 3) of the filter F2_{TCP} by the storage controller 44a.

The comparison with condition 1 is as described above. When comparing the packet data with condition 2 of the TCP system, the condition judging positions thereof are the positions of a higher level protocol number 86 of the IP header 82 (see FIG. 10), a destination port number 88 of the TCP header 84 (see FIG. 11), and an SYN flag 89 (see FIG. 11). If the higher level protocol number 86 of the packet data expresses a TCP number, the destination port number 88 of the TCP header 84 expresses an SNMP number and the SYN flag 89 is 1, the packet data corresponds to condition 2.

Further, when comparing the packet data and condition 3 of the TCP system, the condition judging positions are the same as condition 2. However, if the higher level protocol number 86 of the packet data expresses a TCP number, the destination port number 88 of the TCP header 84 expresses an LPR number and the SYN flag 89 is 1, the packet data corresponds to condition 3.

Here, because the packet data of the TCP_SYNC request of SNMP corresponds to “condition 2” of the filter F2_{TCP}, the packet data is stored in the FIFO 60, and is further stored in the main memory 30 by DMA transfer, as described with reference to FIG. 6A. Further, the selection signal 2 is generated by the selection controller 44b in accordance with the selection rules shown in FIG. 5A such that the condition memory 54 that stores the filter F3_{TCP} is selected. After the write signal becomes L level as described above, the selection signal 2 is transmitted to the selector 52 during the time period until the next packet data is received. Due thereto, the condition memory 54 in which the filter F3_{TCP} is stored is selected.

Moreover, when the CPU 24 receives a packet storage notification from the reception controller 34, the CPU 24 reads-out that stored packet data from the main memory 30 and generates a response to the TCP_SYNC request. As shown in (7) of FIG. 7, the CPU 24 transmits the packet data of the TCP_SYNC response to the network via the transmission controller 36 and the communication interface 22.

Thereafter, as shown in (5) of FIG. 7, when an SNMP command (a packet of protocol “TCP” and port number “SNMP”) is received, that packet data is compared with the respective conditions of the filter F3_{TCP} (conditions 1 through 4) by the storage controller 44a.

The comparison with conditions 1 through 3 is the same as described above. When comparing the packet data with condition 4 of the TCP system, the condition judgment positions thereof are the positions of the higher level protocol number 86 of the IP header 82 (see FIG. 10) and the destination port number 88 of the TCP header 84 (see FIG. 11). If the higher level protocol number 86 of the packet data indicates a TCP number and the destination port number 88 of the TCP header 84 indicates an SNMP number, the packet data corresponds to condition 4.

Because the packet data of the SNMP command corresponds to “condition 4” of the filter F3_{TCP}, the packet data is stored in the FIFO 60 and is further stored in the main memory 30 by DMA transfer as described with reference to FIG. 6A. Further, in the selection rules shown in FIG. 5A, if the packet data corresponds to condition 4, changing of the selection of the condition memory 54 is not carried out.

Note that, if the received packet data corresponds to condition 3 when the condition memory 54 that stores the filter F3_{TCP} is selected, the selection signal 4 is generated by the selection controller 44b in accordance with the selection rules shown in FIG. 5A so that the condition memory 54 that stores the filter F5_{TCP} is selected. As described above, after the write signal becomes L level, the selection signal 4 is transmitted to the selector 52 during the time period until the next packet data is received. Due thereto, the condition memory 54 in which the filter F5_{TCP} is stored is selected. Further, if packet data is received when the condition memory 54 that stores the filter F5_{TCP} is selected, each of the conditions 1 through 5 and the received packet data are compared. The comparison with conditions 1 through 4 is as described above. When comparing the packet data with condition 5 of the TCP system, the condition judging positions thereof are the positions of the higher level protocol number 86 of the IP header 82 (see FIG. 10) and the destination port number 88 of the TCP header 84 (see FIG. 11). If the higher level protocol number 86 of the packet data expresses a TCP number and the destination port number 88 of the TCP header 84 expresses an LPR number, the packet data corresponds to condition 5.

Note that, when packet data of an image formation request in LPR protocol is received, the CPU 24 carries out control on the basis of the image formation request such that image formation is carried out at the image forming section 16.

In this way, the conditions of the filter stored in the selected condition memory 54 and the received packet data are compared, and if, as a result of the comparison, the packet data corresponds to any of the conditions, that packet data is stored. Further, the condition memory 54, in which is stored the filter that corresponds to the conditions corresponding to the object packet data that is to be stored, is selected to be applied with respect to the packet data that is received next.

An example of reception control of packet data of the TCP system has been described here, but reception control of packet data of the ICMP system is carried out similarly to that described above.

When comparing received packet data and condition 1 of the ICMP system, comparison is carried out in the same way as comparison to condition 1 of the TCP system. If received packet data corresponds to condition 1 when the condition memory 54 storing filter F1_{ICMP} is selected, in order to switch from the power saving mode to the non power saving mode, the power source controller 32 transmits to the power source supply controller 28 a power source supply control signal for restarting the supply of electric power to the CPU 24, and, as described above, the interruption controller 44c transmits an interruption signal for activating the CPU 24.

When comparing the received packet data and condition 2 of the ICMP system, the condition judgment positions thereof are the positions of the higher level protocol number 86 of the IP header 82 (see FIG. 10) and a type 87 of the ICMP header 83 (see FIG. 10). If the higher level protocol number 86 of the packet data indicates an ICMP number and the type 87 indicates a request number, the packet data corresponds to condition 2. When comparing the received packet data and condition 3 of the ICMP system, the condition judgment position is only the higher level protocol number 86 of the IP header 82 (see FIG. 10). If the higher level protocol number 86 of the packet data indicates an ICMP number, the packet data corresponds to condition 3.

Exemplary embodiments are not limited to the exemplary embodiment that is described above, and various changes in terms of design may be carried out within the scope of the invention recited in the claims.

For example, the above exemplary embodiment describes examples of reception control of packet data of TCP protocol and ICMP protocol. However, the embodiment is not limited to the same, and may be applied also to packet data of various protocols such as, for example, packet data of UDP protocol or the like.

The exemplary embodiment describes an example of using a DRAM as the main memory 30. However, the main memory 30 is not limited to the same, and, for example, an SRAM (Static Random Access Memory) may be used. In this case, the refreshing operation is not necessary.

Further, the above exemplary embodiment describes an example of selecting one condition memory 54 from the plural condition memories 54, i.e., switching the filter that is used. However, the embodiment is not limited to the same. For example, the reception controller 34 may be structured such that different conditions are stored in respective plural condition memories 54, and condition memories 54 that are to be used are gradually added. A concrete example of adding conditions in this way will be described below by using filters of the TCP system as an example.

In advance, condition 1 is stored in the first condition memory 54 of the TCP system, condition 2 is stored in the second condition memory 54, condition 3 is stored in the third condition memory 54, condition 4 is stored in the fourth condition memory 54, and condition 5 is stored in the fifth condition memory 54. Conditions 1 through 5 are the conditions that have been described with reference to FIG. 4A.

When the image forming device 10 transitions to the power saving mode, only the first condition memory 54, in which condition 1 is stored, is selected by a selection signal of the selection controller 44b (this state functions as filter F1_{TCP}). In the power saving mode, if packet data corresponding to condition 1 is received, that packet data is stored by control of the storage controller 44a. Further, in this case, on the basis of the selection rules of the selection rule memory 46 shown in FIG. 5A, while maintaining the first condition memory 54 being continuously selected, the selection controller 44b generates a selection signal such that the second condition memory 54 that stores condition 2 and the third condition memory 54 that stores condition 3 are additionally selected, and transmits the selection signal to the selector 52. As described by using FIG. 6B, the transmitting of the selection signal is carried out during the period of time from after the write signal becomes L level until the next packet data is received. Due thereto, a state in which the first through third condition memories 54 are selected arises (this state functions as filter F2_{TCP}). Note that, at this time, the CPU 24 as well is activated and moved-on to the non power saving mode.

If packet data corresponding to condition 2 is received while the first through third condition memories 54 are selected, that packet data is stored by control of the storage controller 44a. Further, in this case, on the basis of the selection rules of the selection rule memory 46 shown in FIG. 5A, while maintaining the first through third condition memories 54 being continuously selected, the selection controller 44b generates a selection signal such that the fourth condition memory 54 that stores condition 4 is additionally selected, and transmits the signal to the selector 52. As described by using FIG. 6B, the transmitting of the selection signal is carried out during the period of time from after the write signal becomes L level until the next packet data is received. Due thereto, a state in which the first through fourth condition memories 54 are selected arises (this functions as filter F3_{TCP}).

As described above, conditions may be added (i.e., the condition memories 54 that are selected may be added) in accordance with conditions to which the object packet data corresponds. Due thereto, the storage capacity needed for the condition memories 54 can be reduced.

Further, the exemplary embodiment describes an example in which the condition memory 54 that is used is switched in turn to a condition memory 54 that stores a filter having a greater number of conditions. However, depending on the conditions that the received packet data corresponds to, the condition memory 54 that is used can be switched to a condition memory 54 that stores a filter having fewer conditions than the conditions that are stored in the currently-selected condition memory 54.

For example, the condition “the higher level protocol number 86 indicates a TCP number, the destination port number 88 of the TCP header 84 indicates an LPR number, and a FIN flag 91 is 1” may be added in advance to the filter F4_{TCP}. Further, the selection controller 44b may be configured such that when packet data corresponding to these conditions within a communication by LPR protocol is received, generates a selection signal so as to switch to the filter F1_{TCP} or the filter F2_{TCP}. Because packet data at which the FIN flag 91 is 1 means end of connection, communication by LPR protocol is not started until packet data whose SYN flag 89 is 1 is received next, and therefore, the filter may be switched to the filter F1_{TCP} or the filter F2_{TCP}. Further, at the device that transmits the packet data of the SYN request, if packet data having the SYN flag 89 of 1 is discarded by the filter F1_{TCP} and a response is not obtained, communication may be re-tried from the ARP request, and therefore, the filter may be switched to the filter F1_{TCP}.

Note that, if a structure in which different conditions are stored respectively in the plural condition memories 54 is used and the conditions are control to be reduce, the selection controller 44b generates a selection signal for canceling selection of the condition memory 54 that is not used, and transmits the signal.

What is claimed is:

1. A receiver comprising:
a first storage unit for storing at least one packet data;
a plurality of second storage units respectively storing at least one condition associated with packet data to be stored in the first storage unit;
a selector selecting at least one second storage unit from the plurality of second storage units in accordance with a selection signal;
a storage controller that, if a received packet data corresponds to any condition stored in a selected second storage unit, stores the packet data in the first storage unit, and, if the received packet data does not correspond to any condition, discards the packet data; and
a selection controller generating a selection signal for selecting, from the plurality of second storage units, at least one second storage unit in accordance with conditions to which the packet data stored by the storage controller corresponds, and transmitting the selection signal to the selector.

2. The receiver of claim 1, wherein the selection controller generates and transmits the selection signal such that selection of the second storage unit is carried out during a time period lasting from after packet data is stored in the first storage unit until a next packet data is received.

3. The receiver of claim 1, further comprising a selection rule storage unit that stores selection rules that determine at least one second storage unit to be selected next, in accordance with conditions to which the packet data stored by the storage controller corresponds,
wherein the selection controller generates the selection signal by referring to the selection rule storage unit.

4. The receiver of claim 1, further comprising an interruption controller that, if packet data is stored in the first storage unit at a time when a central processing unit is in a stopped state, generates an interruption signal for activating the central processing unit and transmits the interruption signal to the central processing unit.

5. An image forming device comprising:
the receiver of claim 1;
an image forming section forming an image; and
a central processing unit that, if packet data stored at the receiver is data requesting image formation, controls the image forming section to form an image.

6. The image forming device of claim 5, wherein the receiver further comprises an interruption controller that, if packet data is stored in the first storage unit at a time when the central processing unit is in a stopped state, generates an interruption signal for activating the central processing unit and transmits the interruption signal to the central processing unit.

7. A data reception method comprising:
storing respectively in a plurality of second storage units at least one condition associated with packet data to be stored in a first storage unit;
selecting at least one second storage unit from the plurality of second storage units in accordance with a selection signal;
if a received packet data corresponds to any condition stored in a selected second storage unit, storing the packet data in the first storage unit, and, if the received packet data does not correspond to any condition, discarding the packet data; and
generating a selection signal for selecting, from the plurality of second storage units, at least one second storage unit in accordance with conditions to which the packet data stored in the first storage unit corresponds, and transmitting the selection signal for use in the selecting process.

8. A storage medium storing a program causing a computer to execute data reception processing, the processing comprising:
storing respectively in a plurality of second storage units at least one condition associated with packet data to be stored in a first storage unit;
selecting at least one second storage unit from the plurality of second storage units in accordance with a selection signal;
if a received packet data corresponds to any condition stored in a selected second storage unit, storing the packet data in the first storage unit, and, if the received packet data does not correspond to any condition, discarding the packet data; and
generating a selection signal for selecting, from the plurality of second storage units, at least one second storage unit in accordance with conditions to which the packet data stored in the first storage unit corresponds, and transmitting the selection signal for use in the selecting process.
